(19) United States
(12) Patent Application Publication
(10) Pub. No.: US 2004/0185993 A1
(43) Pub. Date: Sep. 23, 2004

(54) Sheet folding apparatus, sheet processing apparatus and image forming apparatus

(75) Inventor: Raita Doi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 10/661,537

(22) Filed: Sep. 15, 2003

(30) Foreign Application Priority Data
Mar. 20, 2003 (JP) P2003-079173

(51) Int. Cl. B31B 1/26

(52) U.S. Cl. 493/231

(57) ABSTRACT

A sheet folding apparatus has a sheet folding unit which can apply at least letter folding on a sheet, and a folding mode selecting device which can selectively cause the sheet folding unit to operate in a letter folding mode. The apparatus further has a control device which controls the sheet folding unit in accordance with the folding mode selected by the folding mode selecting device. A sheet processing apparatus using the sheet folding apparatus, and an image forming apparatus connectable to the sheet folding apparatus are also disclosed.

The present disclosure relates to the subject matter contained in Japanese Patent Application No. 2003-079173 filed Mar. 20, 2003, which is incorporated herein by reference in its entirety.

### BACKGROUND OF THE INVENTION

1. Field of the Invention

The present invention relates to a sheet folding apparatus that applies a folding process on a sheet, and more particularly to a sheet folding apparatus that can perform a letter folding process on a sheet, a sheet processing apparatus using such a sheet folding apparatus, and an image forming apparatus that is connectable to such a sheet folding apparatus.

2. Description of the Related Art

Usually, a sheet folding apparatus is often included as one of sheet postprocessing apparatuses. In a sheet processing apparatus in which sheet postprocessing apparatuses (including a sheet folding apparatus) are added to an image forming apparatus, for example, a sheet on which an image has been formed by the image forming apparatus is subjected to a predetermined folding process (for example, Z-folding) by the sheet folding apparatus that is one of the sheet postprocessing apparatuses.

A conventional sheet folding apparatus is configured in the following manner. As shown in FIGS. 23A to 23D, for example, a folding roll 500 in which three roll members 501 to 503 sequentially contactingly roll is disposed, and two stop guides 511, 512 against which the tip end of a sheet S or that of a folded portion are placed in the vicinity of the folding roll 500 (for example, see JP-A-2001-26345 (Mode for Carrying Out the Invention, FIG. 1) and JP-A-2001-328763 (Mode for Carrying Out the Invention, FIG. 2)).

In the prior art examples of this kind, as shown in FIG. 23A, the tip end of the sheet S butts against the first stop guide 511. Thereafter, as shown in FIG. 23B, a first folded part of the sheet S is fed between the first and second roll members 501, 502 of the folding roll 500 with using buckling of the sheet S, and the sheet is nip-transported, thereby forming a first folded portion S_{A}. The tip end of the first folded portion S_{A} is then caused to butt against the second stop guide 512. As shown in FIG. 23C, a second folded part of the sheet S is fed between the second and third roll members 502, 503 of the folding roll 500, and the sheet is nip-transported, thereby forming a second folded portion S_{B}. As a result, the sheet S that has been subjected to the Z-folding process is obtained as shown in FIG. 23D.

As described above, in a conventional sheet folding apparatus, Z-folding (in which one of two parts on both sides of a folded portion is further folded) or two-folding is enabled, but letter folding (three-folding for allowing the sheet to be put into an envelope, such as letter C-folding in which a sheet is inward folded three times, and letter Z-folding in which a sheet is outward folded three times) is not considered, thereby producing a technical problem in that letter folding cannot be performed.

### SUMMARY OF THE INVENTION

The invention has been conducted in order to solve the technical problem, and provides a sheet folding apparatus that can perform at least letter folding, a sheet processing apparatus using such a sheet folding apparatus, and an image forming apparatus that is connectable to such a sheet folding apparatus.

According to one aspect of the invention, there is provided a sheet folding apparatus including: a sheet folding unit which can apply at least letter folding on a sheet; and a folding mode selecting device which can selectively cause the sheet folding unit to operate in a letter folding mode.

According to another aspect of the invention, there is provided a sheet folding apparatus including: a sheet folding unit which can apply at least both Z-folding and letter folding on a sheet; and a folding mode selecting device which can selectively cause the sheet folding unit to operate in either of folding modes.

According to still another aspect of the invention, there is provided a sheet processing apparatus having: a sheet folding apparatus including a sheet folding unit which can apply at least letter folding on a sheet, and a folding mode selecting device which can selectively cause the sheet folding unit to operate in a letter folding mode.

According to still another aspect of the invention, there is provided a sheet processing apparatus having: a sheet folding apparatus including a sheet folding unit which can apply at least both Z-folding and letter folding on a sheet, and a folding mode selecting device which can selectively cause the sheet folding unit to operate in either of folding modes.

According to still another aspect of the invention, there is provided a sheet processing apparatus including: an image forming apparatus which applies an image forming process on a sheet; and a sheet postprocessing apparatus which includes a sheet folding apparatus having a sheet folding unit that can apply at least letter folding on a sheet and a folding mode selecting device that can selectively cause the sheet folding unit to operate in a letter folding mode, and which applies a predetermined postprocess on the sheet that has been subjected to the image forming process by the image forming apparatus.

According to still another aspect of the invention, there is provided a sheet processing apparatus including: an image forming apparatus which applies an image forming process on a sheet; and a sheet postprocessing apparatus which includes a sheet folding apparatus having a sheet folding unit that can apply at least both Z-folding and letter folding on a sheet and a folding mode selecting device that can selectively cause the sheet folding unit to operate in either of folding modes, and which applies a predetermined postprocess on the sheet that has been subjected to the image forming process by the image forming apparatus.

According to still another aspect of the invention, there is provided an image forming apparatus connectable to a sheet folding apparatus which can apply at least letter folding on a sheet, the image forming apparatus including: a folding mode selecting device which can select a folding mode of the sheet folding apparatus.

### BRIEF DESCRIPTION OF THE DRAWINGS

FIG. 1A is a diagram showing a configuration of a sheet processing apparatus including a sheet folding apparatus according to an embodiment of the invention, and FIG. 1B is a diagram schematically showing the sheet folding apparatus;

FIG. 2 is a diagram showing letter folding and Z-folding, which are to be performed in the sheet folding apparatus;

FIG. 3 is a diagram showing a first embodiment of a sheet processing apparatus;

FIG. 4 is a diagram showing a sheet folding unit which is used in the embodiment;

FIG. 5 is a diagram showing a driving system and sensors which are incorporated into the sheet folding unit;

FIG. 6 is a diagram showing the layout of the sheet folding unit;

FIG. 7A is a view showing a nipping/releasing mechanism for a skew correction roll of the sheet folding unit, and FIG. 7B is a view showing a structure for supporting the skew correction roll;

FIG. 8 is a plan view of the nipping/releasing mechanism;

FIG. 9A is a view showing an end guide moving mechanism, and

FIG. 9B is a bottom view of the mechanism;

FIG. 10A is view showing the configuration of a folding roll, and

FIG. 10B is view showing the configuration of transportation rolls other than a nip/release roll;

FIG. 11A is a diagram showing a sheet accommodating device which is to be incorporated into the sheet folding unit, and

FIG. 11B is a diagram showing a comparative mode of the sheet accommodating device;

FIG. 12 is a perspective view showing in detail the sheet accommodating device used in the embodiment;

FIG. 13A is a view looking in the direction of XIII in FIG. 12, and

FIG. 13B is a view showing a state where a stack tray is extracted;

FIG. 14 is a diagram showing a control system used in the embodiment;

FIGS. 15A to 15C are diagrams showing process steps of letter Z-folding a sheet by the sheet folding unit used in the embodiment;

FIGS. 16A to 16C are diagrams showing process steps of letter C-folding a sheet by the sheet folding unit used in the embodiment;

FIGS. 17A to 17D are diagrams showing process steps of Z-folding a sheet by the sheet folding unit used in the embodiment;

FIG. 18 is a timing chart of various portions of the sheet folding unit in a letter Z-folding mode;

FIG. 19 is a timing chart of various portions of the sheet folding unit in a letter C-folding mode; FIG. 20 is a timing chart of various portions of the sheet folding unit in a Z-folding mode;

FIG. 21 is a diagram showing operation steps of the sheet accommodating device in the embodiment;

FIG. 22 is a diagram showing a modification of the sheet folding unit in the embodiment; and

FIGS. 23A to 23D are diagrams showing an example of a process of Z-folding a sheet in a conventional sheet folding apparatus.

### DESCRIPTION OF THE INVENTION

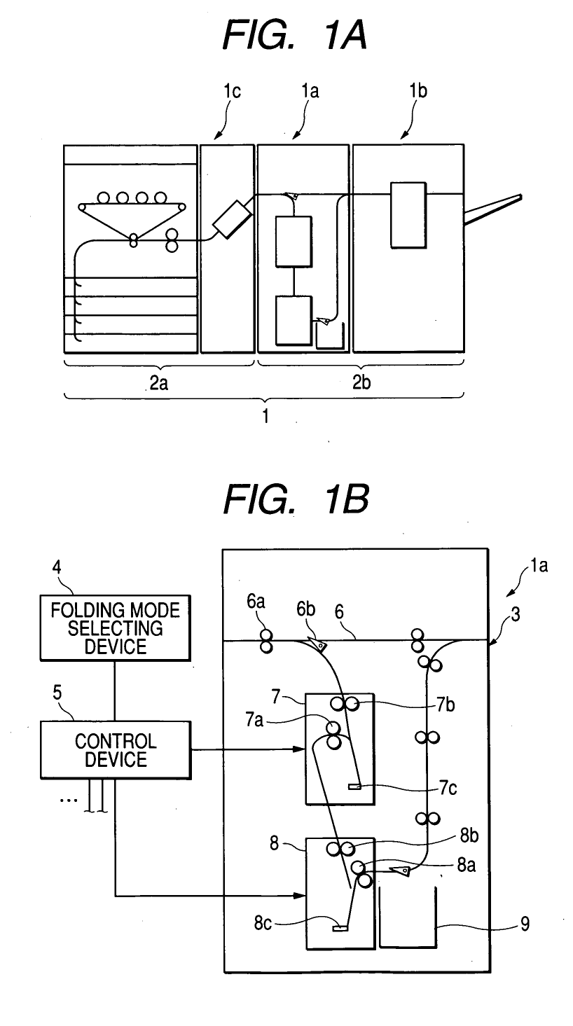

As shown in FIGS. 1A and 1B, the sheet folding apparatus of the invention includes: a sheet folding unit 3 which can apply at least letter folding on a sheet; and a folding mode selecting device 4 which can selectively cause the sheet folding unit 3 to operate in a letter folding mode.

In the technical means, the sheet folding apparatus la applies a folding process on a sheet, and is included in a sheet processing apparatus 1 having a sheet processing section.

In a preferred embodiment, the sheet processing apparatus 1 incorporates in addition to the sheet folding apparatus la a sheet folding postprocessing apparatus 1b which performs a predetermined process(es) (such as a punching process, and a stapling process) after sheet folding, or a sheet folding preprocessing apparatus 1c which performs a predetermined process(es) (such as a curl correcting process) before sheet folding.

As an example of the sheet processing apparatus 1, as shown in FIG. 1A, a sheet postprocessing apparatus(es) 2b is added to an image forming apparatus 2a. As one of the sheet postprocessing apparatuses 2b, the sheet folding apparatus la may be used.

In the technical means, when the sheet folding unit 3 is configured so as to enable at least letter folding, the apparatus may be an apparatus dedicated to letter folding, or a composite apparatus which is combined with another sheet folding unit.

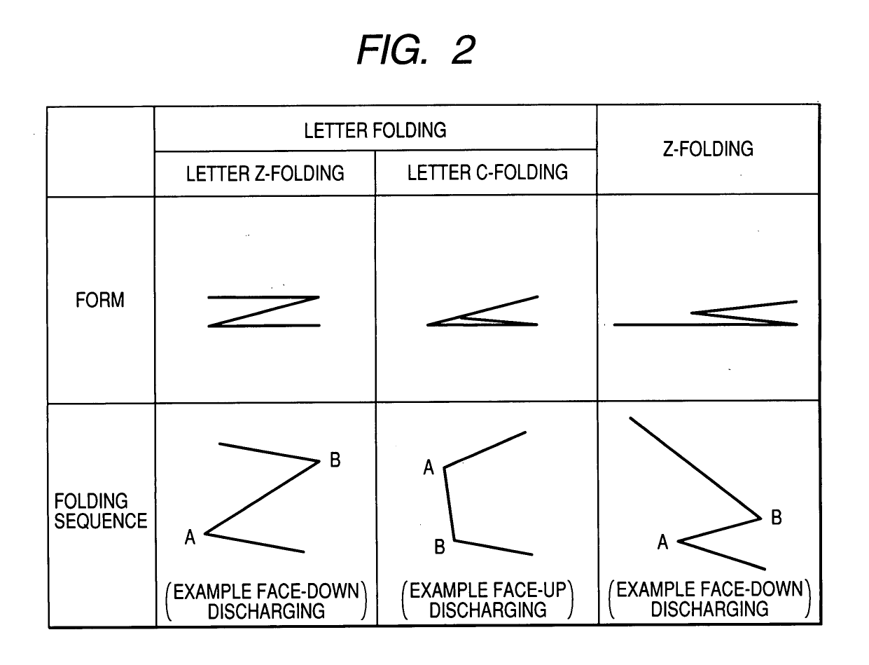

As shown in FIG. 2, letter folding includes letter Z-folding in which a sheet is outward folded three times, and letter C-folding in which a sheet is inward folded three times. One or both of the folding modes are enabled.

The folding mode selecting device 4 may be directly disposed in the sheet folding apparatus 1a, or in another place such as the image forming apparatus 2a in an embodiment in which the device is combined with the image forming apparatus 2a, as far as the device can select the letter folding mode.

When the sheet folding apparatus 1a is regarded as a control system, the invention can be considered so as to, as shown in FIG. 1B, further have a control device 5 which controls the sheet folding unit 3 in accordance with the folding mode selected by the folding mode selecting device 4.

The basic configuration of the sheet folding unit 3 which can perform letter folding has a plurality of folding mechanisms 7, 8 in a sheet path 6.

In letter Z-folding and letter C-folding, for example, a folding process must be performed at two places A and B in this sequence as shown in FIG. 2, and hence the plural folding mechanisms 7, 8 are required. In FIG. 2, the letter Z-folding and the letter C-folding show respectively the cases of the face-down discharging method and the face-up discharging method in which a sheet is discharged with being directed downward or upward.

As shown in FIG. 1B, components such as gate members 6a which switch over the path, and transport members 6b which transport a sheet are adequately arranged along the sheet path 6.

Preferably, each of the folding mechanisms 7, 8 has a folding position changing mechanism which can change a sheet folding position.

The terms “can change a sheet folding position” mean that the sheet folding position (s) can be changed in accordance with the size and kind of a sheet.

Among the folding mechanisms 7, 8, preferably, the upstream folding mechanism 7 has a skew correcting mechanism which applies skew correction on a sheet. When skew correction is performed by the skew correcting mechanism, it is possible to effectively avoid a folding failure due to a sheet skew.

Typically, each of the plural folding mechanisms 7, 8 includes: a folding member 7a or 8a which is disposed in the sheet path 6 to nip-transport a sheet; a transport member 7b or 8b which is disposed in the sheet path 6 upstream from the folding member 7a or 8a to nip-transport the sheet; and a tip end guide member 7c or 8c which is disposed in the sheet path 6 upstream from the folding member 7a or 8a to restrict the position of the tip end of the sheet.

In this case, each of the folding mechanisms 7, 8 operates according to the following principle. A sheet is nip-transported by the transport member 7b or 8b, and the tip end of the sheet butts against the tip end guide member 7c or 8c, thereby buckling the sheet. The buckled sheet is fed to the folding member 7a or 8a, and a folding process is applied to a folding position of the sheet by the folding member 7a or 8a.

Each of the folding mechanisms 7, 8 may be provided with a folding position changing mechanism in which, for example, the tip end guide member 7c or 8c can be moved to change the sheet folding position. The skew correcting mechanism which applies skew correction on a sheet may be configured by the transport member 7b or 8b which can perform nipping and releasing operations, and the tip end guide member 7c or 8c.

From the viewpoint of ensuring the skew correcting operation of the skew correcting mechanism of the embodiment, the skew correcting mechanism is preferably configured so that, after the tip end of the sheet butts against the tip end guide member 7c or 8c, the transport member 7b or 8b transports the sheet by a short distance to form a loop on the side of the tip end of the sheet, and thereafter causes the transport member 7b or 8b to perform the releasing operation.

From the viewpoint of stabilizing the sheet folding operation after skew correction, each of the folding mechanisms 7, 8 is preferably configured so that the transport member 7b or 8b nips a sheet that has been subjected to skew correction by the skew correcting mechanism, the transportation speed of the transport member 7b or 8b is then set to be equal to or lower than that of the folding member 7a or 8a, and the sheet that has been subjected to skew correction is fed to the folding member 7a or 8a.

When the sheet folding apparatus 1a is to be configured so as to enable Z-folding in addition to letter folding, as shown in FIG. 1B, the apparatus includes: a sheet folding unit 3 which can apply at least both Z-folding and letter folding on a sheet; and a folding mode selecting device 4 which can selectively cause the sheet folding unit 3 to operate in either of the folding modes.

When the sheet folding apparatus 1a of the embodiment is regarded as a control system, the invention can be considered so as to further includes a control device 5 which controls the sheet folding unit 3 in accordance with the folding mode selected by the folding mode selecting device 4.

In the embodiment, Z-folding means a three-folding form in which one of two-folded portions is further folded as shown in FIG. 2, and a folding process is performed in, for example, the sequence of A and B. FIG. 2 shows an example of Z-folding in the case of the face-down discharging method in which a sheet is discharged with being downward directed. The letter folding may include at least one of letter Z-folding and letter C-folding.

In the embodiment, preferably, the sheet folding unit 3 is configured so that, as shown in FIG. 1B, Z-folding and letter folding are performed on a sheet by the common folding mechanisms 7, 8.

Alternatively, Z-folding and letter folding may be performed by using separate folding mechanisms. From the viewpoint of simplifying the configuration of the apparatus, however, it is preferable to use the common folding mechanisms 7, 8.

The invention is not restricted to the sheet folding apparatus 1a, and is directed also to a sheet processing apparatus 1 including the sheet folding apparatus 1a (the embodiment in which at least letter folding is enabled, and also the embodiment in which at least Z-folding and letter folding are enabled).

A typical embodiment of such a sheet processing apparatus 1 includes: the sheet folding apparatus 1a; and a sheet folding postprocessing apparatus 1b which performs a predetermined postprocess (es) on a sheet that has been subjected to a folding process by the sheet folding apparatus 1a. A sheet folding preprocessing apparatus 1c which performs a predetermined preprocess(es) before sheet folding may be disposed in front of the sheet folding apparatus 1a.

When the sheet processing apparatus 1 is regarded as a control system, the invention can be considered so as to further includes a control device 5 which controls the sheet folding apparatus 1a and the sheet folding postprocessing apparatus 1b in accordance with a postprocessing mode on the sheet. In the sheet processing apparatus 1 including the sheet folding preprocessing apparatus 1c, the control device 5 controls also the sheet folding preprocessing apparatus 1c.

The postprocessing mode means a wide variety of modes in which a postprocess (including a folding process) on a sheet is selected.

In the sheet processing apparatus 1 of this kind, the control device 5 performs a preferred control example in which a letter-folded sheet is housed into a sheet accommodating device 9 in the sheet folding apparatus 1a, under conditions of performing a letter folding process on the sheet by the sheet folding apparatus 1a.

In a letter-folded sheet, the size in the transportation direction is shorter. Therefore, the process of housing the sheet in the sheet folding apparatus 1a is simpler than that of guiding the sheet toward the sheet folding postprocessing apparatus 1b in a subsequent stage.

This is specifically described. In the case of a sheet size of 8.5×11 [inches] SEF (Short Edge Feed), for example, a letter-folded sheet has a size of 93.1 mm, and, in the case of a sheet size of A4SEF, a letter-folded sheet has a size of 99 mm. In order to transport a letter-folded sheet, therefore, the pitch of the transport members 6b must be set to, for example, about 75 mm, and the number of parts of the transport members 6b is increased, thereby correspondingly increasing the production cost. Also when a letter-folded sheet is to be transported to the sheet folding postprocessing apparatus 1b, the pitch of the transport members 6b must be set to, for example, about 75 mm, and the number of parts of the transport members 6b is correspondingly increased. Furthermore, it is often difficult to ensure a space for disposing postprocessing units such as a punching unit in the sheet folding postprocessing apparatus 1b. From these viewpoints, the sheet accommodating device 9 dedicated to a letter-folded sheet is preferably disposed in the sheet folding apparatus 1a as described above.

In another preferred control example of the control device 5, under conditions of performing Z-folding other than letter folding on a sheet by the sheet folding apparatus 1a, the folded sheet is guided toward the sheet folding postprocessing apparatus 1b.

A Z-folded sheet does not largely adversely affect the sheet transportation except the case of letter folding. After a sheet folding process, a predetermined process(es) (such as a punching process) is often performed. Therefore, it is preferable to guide a Z-folded sheet toward the sheet folding postprocessing apparatus 1b from the viewpoint of convenience.

The sheet processing apparatus 1 may further includes an image forming apparatus 2a.

In this case, as shown in FIG. 1A, the apparatus of the invention includes: the image forming apparatus 2a which applies an image forming process on a sheet; and a sheet postprocessing apparatus 2b which includes the sheet folding apparatus 1a, and which applies a predetermined postprocess on the sheet that has been subjected to the image forming process by the image forming apparatus 2a.

When the sheet processing apparatus 1 is regarded as a control system, the invention can be considered so as to further includes a control device 5 which controls the image forming apparatus 2a and the sheet postprocessing apparatus 2b in accordance with a process mode on the sheet.

The process mode means a wide variety of processes on a sheet, including an image forming mode in the image forming apparatus 2a and a postprocess mode (including a folding mode) in the sheet postprocessing apparatus 2b.

The invention is directed also to a single image forming apparatus 2a connectable to the sheet folding apparatus 1a.

In this case, as shown in FIGS. 1A and 1B, the invention provides an image forming apparatus 2a connectable to a sheet folding apparatus 1a which can apply at least letter folding on a sheet, wherein the image forming apparatus includes a folding mode selecting device 4 which can select the folding mode of the sheet folding apparatus 1a.

In an embodiment, the folding mode selecting device 4 of the sheet folding apparatus 1a is disposed on the side of the image forming apparatus 2a. The invention is directed also to an image forming apparatus of this kind.

### DETAILED DESCRIPTION OF THE PREFERRED EMBODIMENTS

Hereinafter, the invention will be described in detail on the basis of embodiments shown in the accompanying drawings.

### First Embodiment

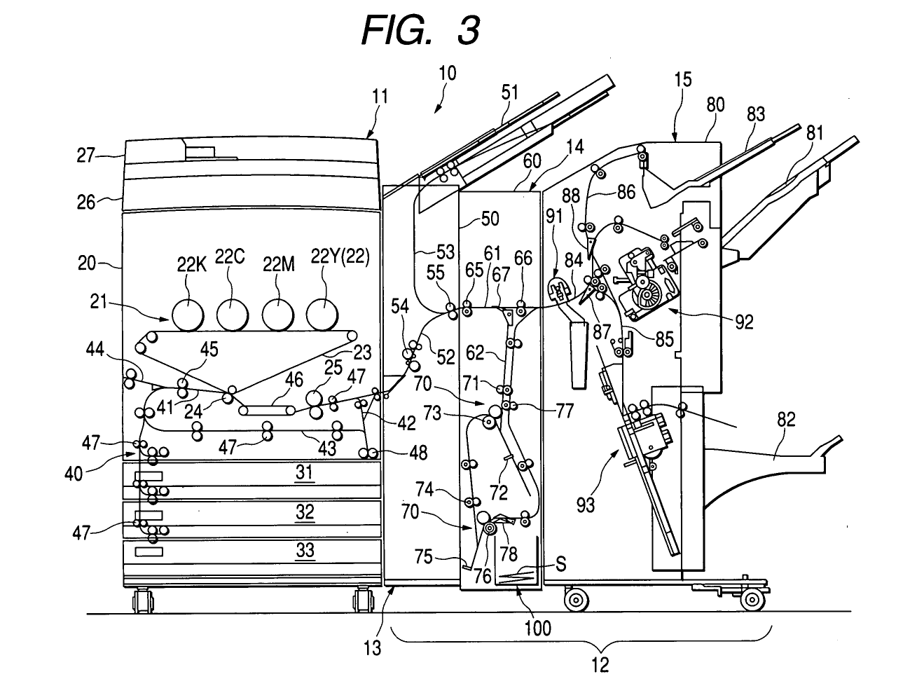

FIG. 3 is a diagram showing a first Embodiment of a sheet processing apparatus to which the invention is applied.

Referring to the figure, the sheet processing apparatus 10 includes: an image forming apparatus 11 which incorporates an image forming section serving as a sheet processing section; and a sheet postprocessing apparatus 12 which applies a postprocess on a sheet S that has been subjected to the image forming process by the image forming apparatus 11.

In the embodiment, the sheet postprocessing apparatus 12 includes: a transport unit 13 which is disposed adjacent to the image forming apparatus 11; a sheet folding unit 14 which applies a folding process on the sheet S that is introduced through the transport unit 13; and a finisher 15 which applies a predetermined final process on the sheet S that has passed through the sheet folding unit 14.

In the embodiment, the image forming apparatus 11 is configured in the following manner. An image reading device 26 which reads an original is disposed in an upper portion of an apparatus case 20. A document feeding device 27 which feeds an original to the image reading device 26 is placed above the reading device. An image forming module 21 which forms toner images of color components (for example, yellow (Y), magenta (M), cyan (C), and black (K)) by, for example, the electrophotographic method is placed inside the apparatus case 20. Multiple sheet trays 31 to 33 are arranged below the image forming module 21.

In the image forming module 21 used in the embodiment, photosensitive drums 22 (specifically, 22Y, 22M, 22C, and 22K) on which color component toner images are respectively formed and carried are arranged in parallel. The color component toner images are primary-transferred to an intermediate transfer belt 23. The color component toner images on the intermediate transfer belt 23 are secondary-transferred to the sheet S supplied from the sheet trays 31 to 33 by a secondary transferring device (such as a secondary transfer roll) 24. The sheet is then guided to a fixing device 25.

In the embodiment, a transportation path 40 elongated from the sheet trays 31 to 33 includes: a main transportation path 41 which is upward directed from a side of the apparatus case 20 opposite to the side of the sheet postprocessing apparatus 12, and then elongated toward the sheet postprocessing apparatus 12 via the secondary transfer position of the image forming module 21 and the fixing device 25; a reversing transportation path 42 which is formed into a substantially Y-like shape below a vicinity of an exit of the main transportation path 41, and which transports the sheet S while reversing the sheet; and a returning transportation path 43 which returns the reversed sheet S to the main transportation path 41 in front of the image forming module 21.

The reference numeral 44 denotes a manual transportation path which is opened in the side of the apparatus case 20 opposite to the side of the sheet postprocessing apparatus 12, and which is communicatingly connected to a horizontal portion of the main transportation path 41.

A registration roll 45 which registers the sheet S and then transports the sheet is disposed in the main transportation path 41 upstream from the secondary transfer position. A transportation belt 46 which transports the sheet to the fixing device 25 is disposed downstream from the secondary transfer position. An adequate number of transportation rolls 47 are disposed in the transportation paths 41 to 44. A reversing mechanism 48 which reverses the sheet S and then transports the sheet is disposed in the reversing transportation path 42.

The transport unit 13 of the sheet postprocessing apparatus 12 has an inserter 51 which is placed above a unit case 50. A first transportation path 52 which transports the sheet S discharged from the image forming apparatus 11, and a second transportation path 53 which transports the sheet S inserted from the inserter 51 are disposed inside the unit case 50 so as to join together in the vicinity of the exit. A decurler 54 which adjusts curling of the sheet S is disposed in the middle of the first transportation path 52. A discharge roll 55 is disposed in the joining area of the transportation paths 52 and 53.

The inserter 51 is used for inserting a special sheet (insert sheet) different from usual sheets, such as the top page, the last page, or an intermediate page of the sheets S.

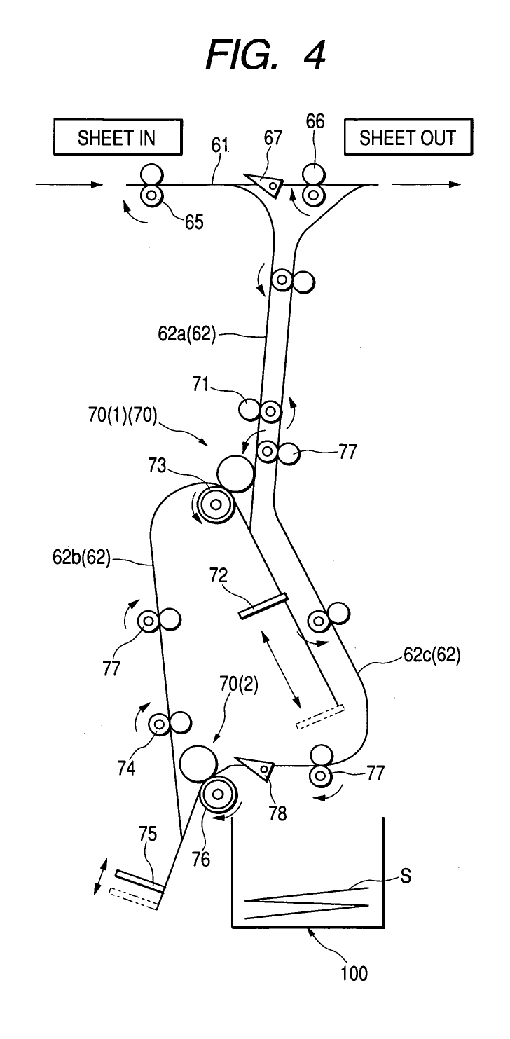

As shown in FIGS. 3 and 4, the sheet folding unit 14 includes: a linear transportation path 61 serving as a sheet path which linearly connects an entrance for the sheet S opened in an upper side portion of a unit case 60 with an exit for the sheet S; and a bypass transportation path 62 serving as a sheet path which branches from the linear transportation path 61 to form a bypass in the lower side. A plurality of folding mechanisms 70 (specifically, 70(1) and 70(2)) are disposed in the bypass transportation path 62.

In the embodiment, an intake roll (transportation roll) 65 is disposed in the entrance of the linear transportation path 61, and a transportation roll 66 is disposed in the middle of the linear transportation path 61. A first switch gate 67 is disposed in the branching area of the linear transportation path 61 and the bypass transportation path 62.

The bypass transportation path 62 includes: an entrance bypass transportation path 62a which downward elongates from the branching area with respect to the linear transportation path 61; an intermediate bypass transportation path 62b which branches in a substantially C-like shape from the entrance bypass transportation path 62a; and a return bypass transportation path 62c which branches from the intermediate bypass transportation path 62b.

The first folding mechanism 70(1) is configured by: a skew correction roll (serving also as a transportation roll) 71 which is disposed in the middle of the entrance bypass transportation path 62a, and just in front of a first folding position, and which can perform nipping and releasing operations; a first end guide 72 which is disposed in the vicinity of the end of the entrance bypass transportation path 62a so as to be vertically movable; and a first folding roll 73 which is disposed in the intermediate bypass transportation path 62b and in the vicinity of the entrance bypass transportation path 62a.

By contrast, the second folding mechanism 70(2) is configured by: a push roll (serving also as a transportation roll) 74 which is disposed in the middle of the intermediate bypass transportation path 62b, and just in front of a second folding position; a second end guide 75 which is disposed in the vicinity of the end of the intermediate bypass transportation path so as to be vertically movable; and a second folding roll 76 which is disposed at the second folding position in the return bypass transportation path 62c and in the vicinity of the intermediate bypass transportation path 62b.

A second switch gate 78 which switches over whether passage to the return bypass transportation path 62c is allowed or not is disposed just in rear of the second folding roll 76. A sheet accommodating device 100 which is to house letter-folded sheets (sheets which have been folded into a shape suitable for putting into an envelope) S is disposed substantially below the second switch gate 78.

In addition to the skew correction roll 71 and the push roll 74, an adequate number of transportation rolls 77 are disposed in the bypass transportation path 62.

In the embodiment, the finisher 15 has two discharge trays 81, 82 on the side portion of a finisher case 80, and a discharge tray (top tray) 83 on the finisher case 80.

In the finisher case 80, a first transportation path 84 elongates toward the discharge tray (large-capacity tray) 81, a second transportation path 85 which branches from the first transportation path 84 elongates toward the discharge tray (bucket tray) 82, and a third transportation path 86 which branches from the first transportation path 84 elongates toward the discharge tray (top tray) 83. The reference numerals 87, 88 denote switch gates for switching over branching transportation paths.

A puncher 91 is disposed in an entrance of the first transportation path 84, a stapler 92 is disposed in the vicinity of the end of the first transportation path 84, and a saddle stitch stapler 93 for a binding process is disposed in the vicinity of the end of the second transportation path 85.

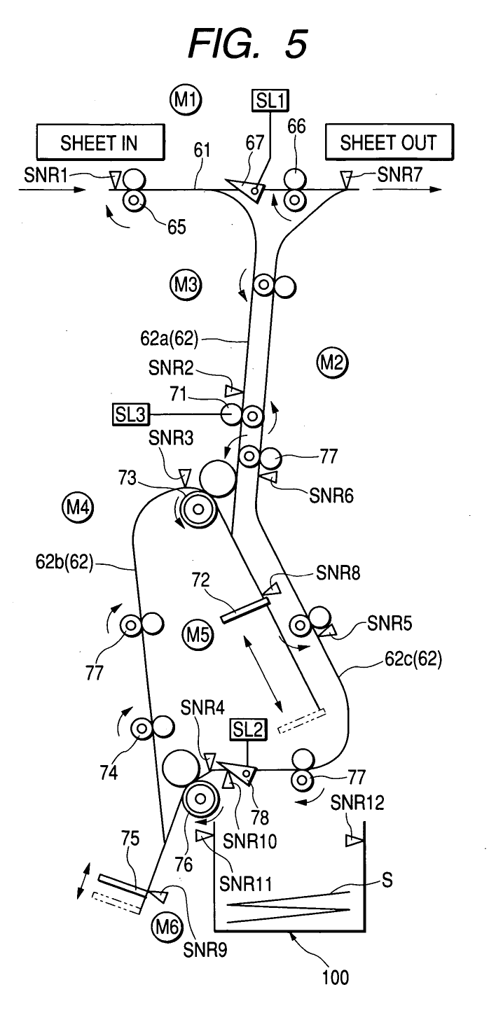

In the embodiment, as shown in FIG. 5, motors M1 to M6, solenoids SL1 to SL3, and various sensors SNR1 to SNR12 are disposed in the sheet folding unit 14.

Specifically, the motors M1 to M6 are configured in the following manner.

M1: This motor is a folding unit entrance motor (Folder Entrance Motor), and drives the transportation rolls 65, 66 at a normal speed v1 (for example, 800 mm/sec.).

M2: This motor is a first drive motor (Folder Drive Motor 1) which can be decelerated from the normal speed v1 to a deceleration speed v2, and drives the skew correction roll 71 serving as a transportation roll constituting the folding mechanism 70.

M3: This motor is a second drive motor (Folder Drive Motor 2) which operates at a constant speed (in the embodiment, the deceleration speed v2:, for example, 250 mm/sec.), and drives the other transportation rolls.

M4: This motor is a folding roll drive motor (Folding Roll Drive Motor) which operates at a constant speed (in the embodiment, substantially equal to the deceleration speed v2), and drives the folding rolls 73, 76.

M5: This motor is a first end guide motor (Endguide Motor 1), and vertically drives the first end guide 72.

M6: This motor is a second end guide motor (Endguide Motor 2), and vertically drives the second end guide 75.

The solenoids SL1 to SL3 are configured in the following manner.

SL1: This solenoid is a first gate solenoid (Gate Solenoid 1), and switchingly drives the first switch gate 67.

SL2: This solenoid is a second gate solenoid (Gate Solenoid 2), and switchingly drives the second switch gate 78.

SL3: This solenoid is a nip release solenoid (Nip Release Solenoid), and drives the nipping and releasing operations of the skew correction roll 71.

The sensors SNR1 to SNR12 are configured in the following manner.

SNR1: This sensor is an entrance sensor (Folder Entrance Sensor) which is disposed in the vicinity of the intake roll 65, and performs a sheet detection, a jamming detection, and a trigger detection of the folding process.

SNR2 to SNR6: These sensors are path sensors (Folder Path Sensor) which are disposed at predetermined positions in the bypass transportation path 62, and perform a sheet detection and a jamming detection.

SNR7: This sensor is an exit sensor (Folder Exit Sensor) which is disposed in the exit-side joining area of the linear transportation path 61 and the bypass transportation path 62, and performs a sheet detection and a jamming detection.

SNR8: This sensor is a first end guide home sensor (Endguide Home Sensor 1), and detects the home position of the first end guide 72.

SNR9: This sensor is a second end guide home sensor (Endguide Home Sensor 2), and detects the home position of the second end guide 75.

SNR10: This sensor is a second gate solenoid sensor (Gate Solenoid 2 Sensor), and detects the on/off operations of the second switch gate 78.

SNR11: This sensor is a full detection sensor (Envelop Tray Full Sensor) for a stack tray (letter tray) of the sheet accommodating device 100.

SNR12: This sensor is a set sensor (Letter Tray Set Sensor) which detects whether the extractable stack tray (letter tray) of the sheet accommodating device 100 is set to a set position or not.

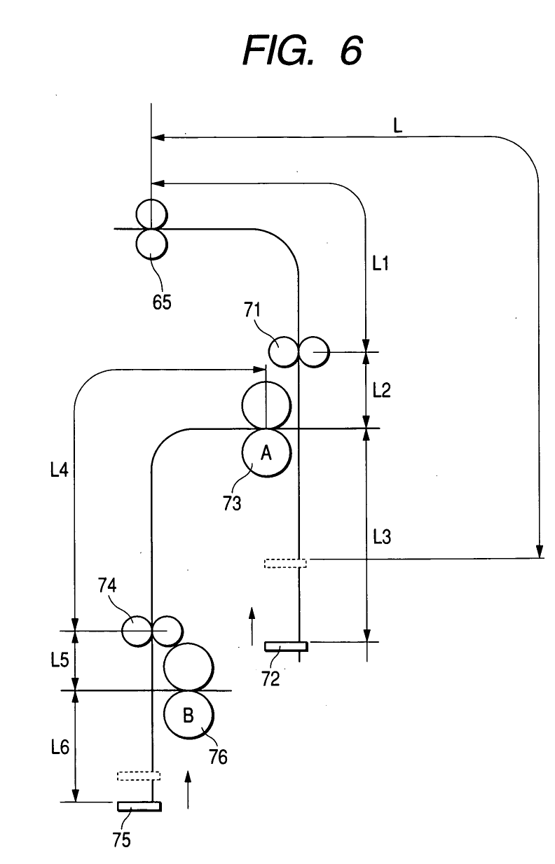

In the embodiment, the layout of the folding mechanisms 70 (70(1) and 70(2)) in the sheet folding unit 14 is set as shown in FIG. 6.

In the embodiment, the maximum size of a sheet to be letter-folded is JIS A4 size, and the minimum size is 8.5×11 [inches]. By contrast, the maximum size of a sheet to be Z-folded is 11×17 [inches], and the minimum size is JIS B4 size.

Referring to the figure, L indicates the length of a sheet path elongating from the intake roll 65 to the first end guide. The length is set to be equal to or larger than the maximum size (in the example, 11×17 [inches]) of a sheet to be Z-folded.

Furthermore, L1 indicates the length of a sheet path elongating from the intake roll 65 to the skew correction roll 71. The length is set to be equal to or smaller than the minimum size (in the example, 8.5×11 [inches]) of a sheet to be letter-folded.

Furthermore, L2 indicates the length of a sheet path elongating from the skew correction roll 71 to a nip position A (corresponding to the first folding position of a sheet) of the first folding roll 73. The length is set to be equal to or smaller than one third of the minimum size (in the example, 8.5×11 [inches]) of a sheet to be letter-folded.

Moreover, L3 indicates the length of a sheet path elongating from the first end guide 72 to the nip position A of the first folding roll 73. The length is set to one third of the size of a sheet to be letter Z-folded, two thirds of the size of a sheet to be letter C-folded, or one fourth of the size of a sheet to be Z-folded.

Furthermore, L4 indicates the length of a sheet path elongating from the first folding roll 73 to the push roll 74. The length is set to be equal to or smaller than one half of the minimum size (in the example, JIS B4 size) of a sheet to be Z-folded.

Furthermore, L5 indicates the length of a sheet path elongating from the push roll 74 to a nip position B (corresponding to the second folding position of a sheet) of the second folding roll 76. The length is set to be equal to or smaller than one third of the minimum size (in the example, 8.5×11 [inches]) of a sheet to be letter-folded.

Moreover, L6 indicates the length of a sheet path elongating from the second end guide 75 to the nip position B of the second folding roll 76. The length is set to two thirds of the size of a sheet to be letter-folded, or one fourth of the size of a sheet to be Z-folded.

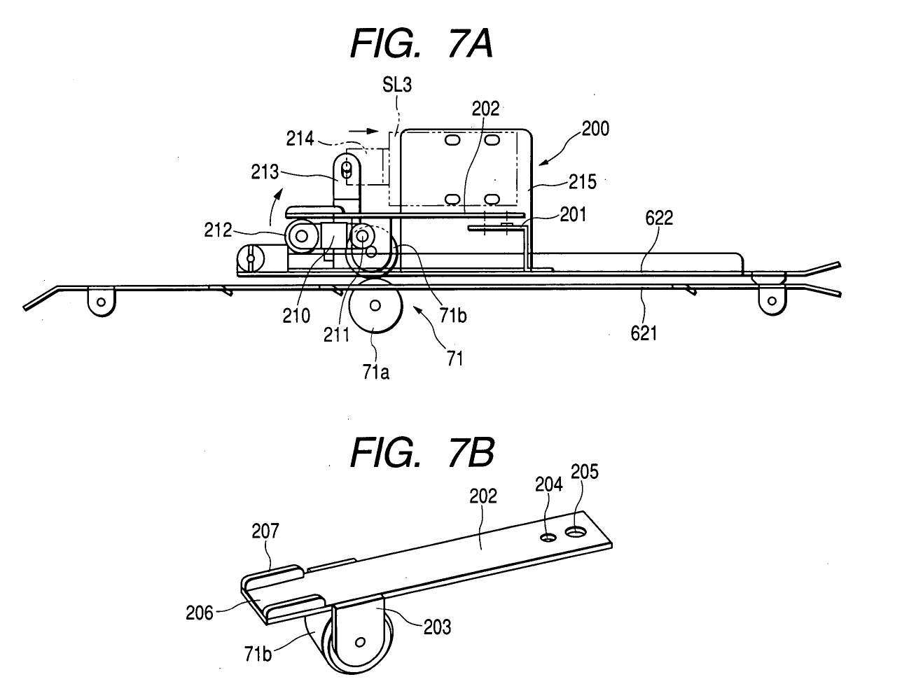

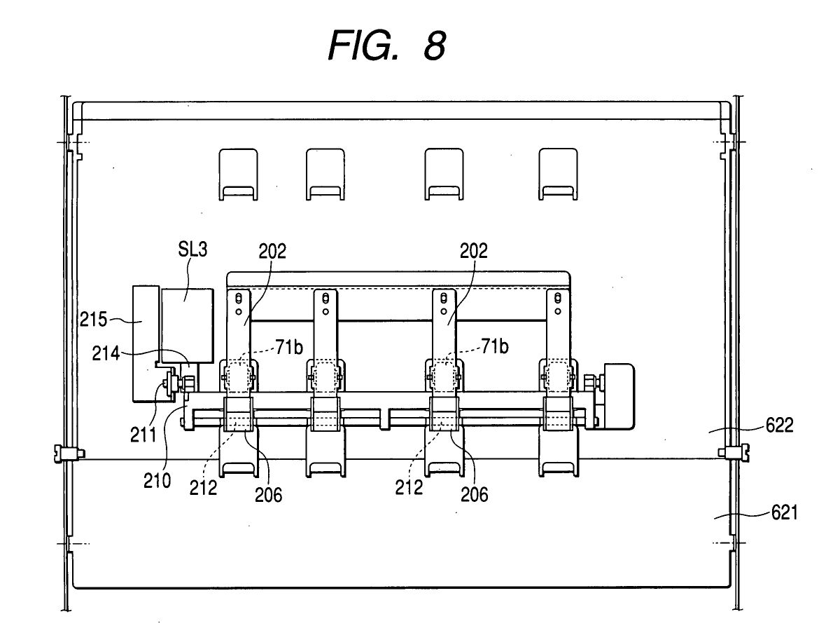

In the embodiment, as shown in FIGS. 7A, 7B, and 8, the skew correction roll 71 is caused to perform a nipping or releasing operation by a nipping/releasing mechanism 200.

Referring to the figures, the skew correction roll 71 is configured by plural driving rolls 71a, and driven rolls 71b which are opposed respectively to the driving rolls 71a. The driven rolls 71b are caused to contact with or separate from the corresponding driving rolls 71a by the nipping/releasing mechanism 200.

The structure for supporting each of the driven rolls 71b is configured in the following manner. One end of a plate spring 202 is secured by a screw or the like via a bracket 201 to one of paired guide chutes 621, 622 defining a sheet path. A pair of support pieces 203 are projected from the side of the free end of the plate spring 202. The driven roll 71b is rotatably supported between the pair of support pieces 203. An attachment hole 204 through which a fixing member such as a screw is to be passed, and a positioning hole 205 with which a positioning pin (not shown) is to be engaged are opened in the plate spring 202.

A projection piece 206 is projected integrally from the free end side of the plate spring 202, and reinforcement flanges 207 are formed on both side ends of the piece, respectively.

By contrast, the nipping/releasing mechanism 200 is configured in the following manner. As shown in FIGS. 7A and 8, a swing arm 210 is disposed so as to be swingable about a rotation shaft 211 elongating in parallel with the axes of the driven rolls 71b. Push-up rollers 212 are rotatably disposed at positions of the free end side of the swing arm 210 corresponding to the projection pieces 206 of the plate springs 202, so as to be in contact with the rear faces of the projection pieces 206, respectively. An engagement piece 213 up stands from one end side of the swing arm 210 with being separated from the rotation shaft 211 by a predetermined distance. An operating rod 214 of the nip release solenoid SL3 is drivingly coupled with the engagement piece 213. The reference numeral 215 denotes a solenoid mounting bracket.

In the nipping/releasing mechanism 200, when the nip release solenoid SL3 is in the off state, the operating rod 214 is extended, so that the push-up rollers 212 of the swing arm 210 do not push the plate springs 202 and the driven rolls 71b are in contact (nip) with the driving rolls 71a.

By contrast, in the nipping/releasing mechanism 200, when the nip release solenoid SL3 is turned on, the operating rod 214 is moved in the direction of the arrow in FIG. 7A. As a result, the swing arm 210 upward swings, and the projection pieces 206 of the plate springs 202 are pushed up by the push-up rollers 212, where by the driven rolls 71b are moved. As a result, the driven rolls 71b are separated (release) from the driving rolls 71a.

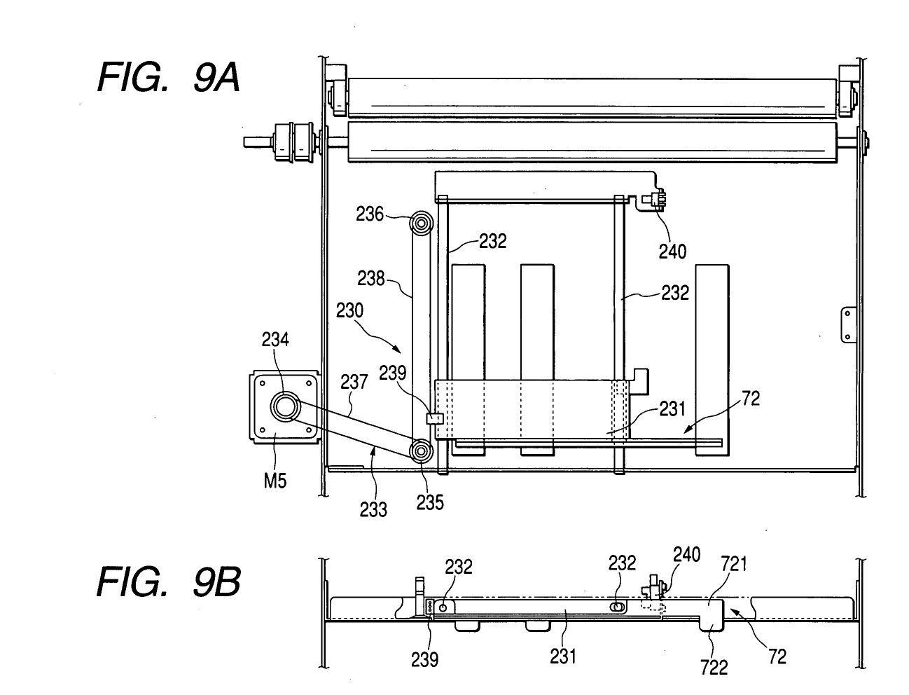

The first end guide 72 is vertically moved by an end guide moving mechanism 230 shown in FIGS. 9A and 9B.

In the embodiment, the first end guide 72 is formed by projecting a plurality of guide projections 722 from a guide body 721.

The end guide moving mechanism 230 has a movable block 231 to which the end guide 72 is fixed. The movable block 231 is disposed so as to be vertically movable along a pair of guide rods 232. A driving force of the end guide motor M5 is transmitted to the movable block 231 through a drive transmitting mechanism 233.

In the drive transmitting mechanism 233, for example, a driving pulley 234 is disposed on the driving shaft of the end guide motor M5. A two-stage driven pulley 235 is disposed in the lower side in the movement direction of the end guide 72, and a one-stage driven pulley 236 is disposed in the upper side. Belts 237, 238 are looped between the driving pulley 234 and the driven pulley 235, and the driven pulleys 235, 236, respectively. An engagement piece 239 of the movable block 231 is fixed to one of the belts, or the belt 238.

In the figure, 240 denotes the home sensor (SNR8) for the first end guide 72.

The second end guide 75 is configured in a similar manner so as to be vertically moved by a mechanism similar to the end guide moving mechanism 230.

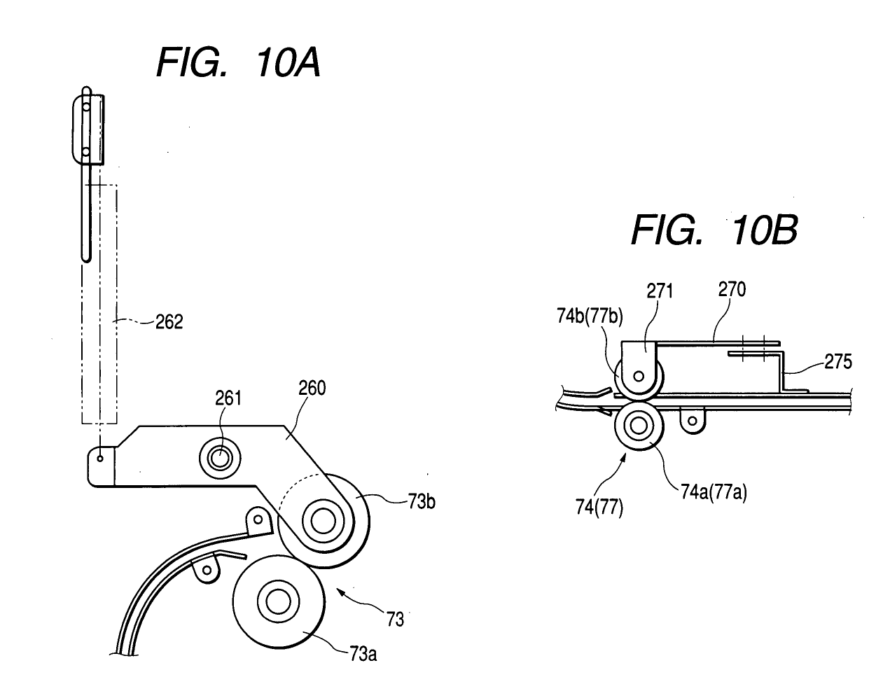

In the embodiment, as shown in FIG. 10A, the first folding roll 73 is configured by a driving roll 73a and a driven roll 73b. The structure for supporting the driven roll 73b has a swing support arm 260 which is supported so as to be swingable about a predetermined rotation shaft 261. The driven roll 73b is rotatably supported by the tip end of the swing support arm 260. An urging force is applied to the swing support arm 260 by an urging spring 262, so that the driven roll 73b is pressed against the driving roll 73a to be in contact (nip) therewith. The structure for supporting the driven roll of the second folding roll 76 is configured in a substantially same manner as the above-described supporting structure.

As shown in FIG. 10B, each of the push roll 74 and the transportation rolls 77 other than the skew correction roll 71 is configured by a driving roll 74a or 77a, and a driven roll 74b or 77b. The structure for supporting the driven roll 74b (77b) is configured so that one end side of a plate spring 270 is attached to a support bracket 275, a pair of support pieces 271 are projected from both the sides in the vicinity of the free end of the plate spring 270, and the driven roll 74b (77b) is supported between the support pieces 271.

In the embodiment, the sheet accommodating device 100 incorporated in the sheet folding unit 14 is configured in the following manner.

As shown in FIGS. 4, 11A, and 12, the sheet accommodating device 100 is dedicated to house letter-folded sheets S, and has the stack tray (letter tray) 110 which is extractable with respect to the unit case 60 (see FIG. 3).

The stack tray 110 has a box-like sheet receiving tray 111 which is upward opened. An extraction operating portion 112 is formed integrally with the front side in the extraction direction of the sheet receiving tray 111.

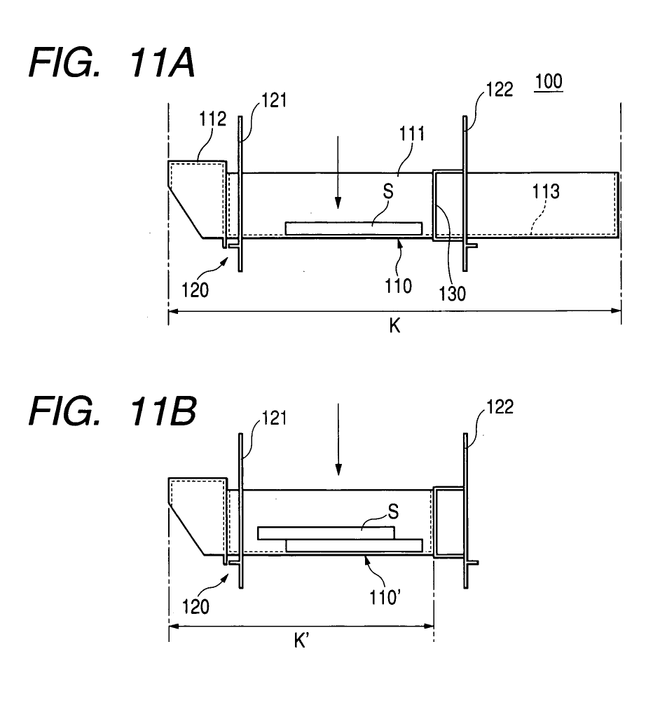

In the embodiment, as shown in FIG. 11A, the length K in the extraction direction of the stack tray 110 is set to be approximately two times the extraction distance of the stack tray 110.

FIG. 11B shows a form model for comparison in which the length K′ in the extraction direction of a stack tray 110′ is approximately equal to the extraction distance of the stack tray 110′. In the stack tray 110, the portion which is beyond the extraction direction length K′ of the stack tray 110′ of FIG. 11B functions as an auxiliary stack portion 113.

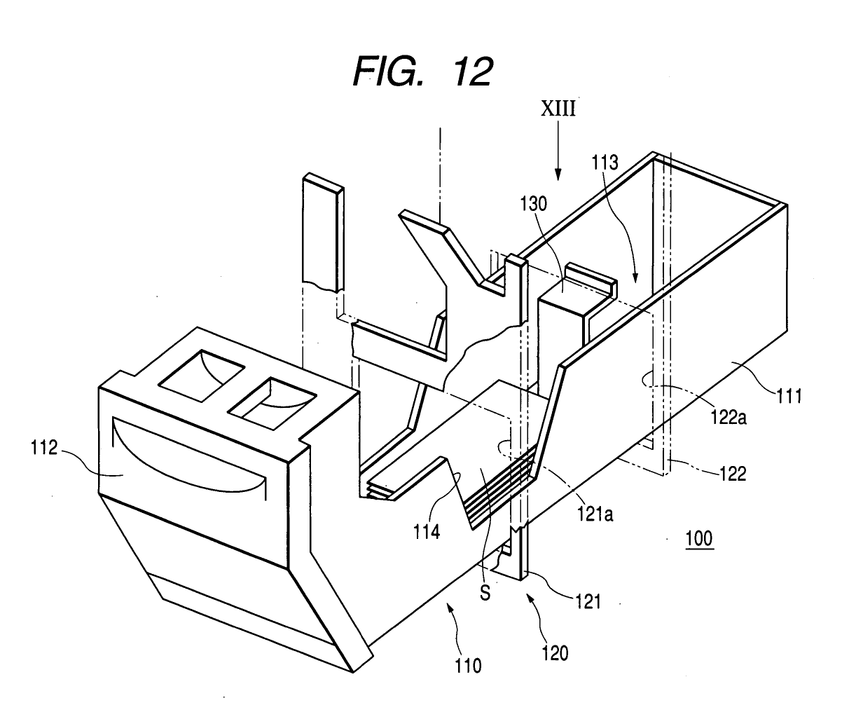

From the viewpoint of facilitating the operation of extracting the stack tray 110, the extraction operating portion 112 is preferably configured so as to be accessible from both the front and upper sides as shown in FIG. 12. In consideration of the workability of taking out the housed sheets S, preferably, a cutaway 114 for taking out sheets is formed in the side of the sheet receiving tray 111.

A supporting mechanism 120 having the following structure supports the sheet receiving tray 111 in an extractable manner. For example, through holes 121a, 122a through which the stack tray 110 is to pass are opened respectively in paired front and rear frames 121, 122 constituting the unit case 60, and the stack tray 110 is movably supported with straddling over the through holes 121a, 122a.

From the viewpoint of stabilizing the operation of extracting the stack tray 110, the supporting mechanism 120 may be adequately configured in another manner. For example, a guide rail (not shown) is laid, a guide shoe is disposed on the stack tray 110, and the guide shoe is slidably fitted onto the guide rail, so that the stack tray 110 can be extracted along the guide rail.

In the embodiment, a stopper 130 is disposed in the through hole 122a of the rear frame 122.

As shown in FIGS. 4 and 12, the stopper 130 is configured by a channel member which has a hat-like section shape, and which vertically crosses the vicinity of the center in the width direction of the through hole 122a. The width of the stopper 130 is set to be sufficiently smaller than that of the through hole 122a.

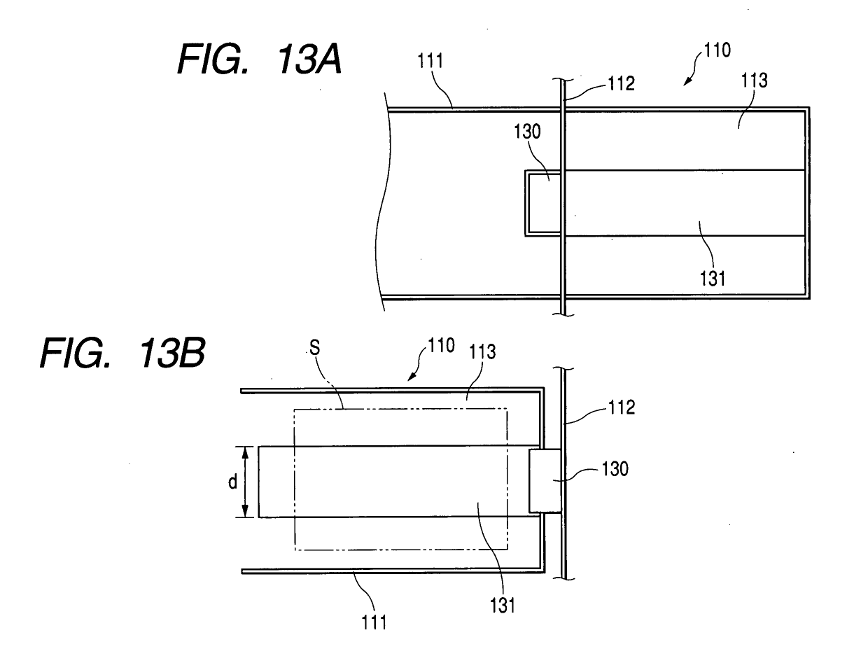

Since the stopper 130 crosses the through hole 122a of the rear frame 122, a slit 131 which elongates in the extraction direction of the stack tray 110 is opened in the bottom of the sheet receiving tray 111 corresponding to the auxiliary stack portion 113 of the stack tray 110 as shown in FIGS. 13A and 13B, thereby preventing the stopper 130 from interfering with the operation of extracting the stack tray 110.

At this time, the width d of the slit 131 is selected so as to substantially correspond to the width of the stopper 130. In the case where the width of the stopper 130 is set to be sufficiently small, there arises no fear that the sheet S drops from the slit 131 even when the sheet S is discharged onto the auxiliary stack portion 113.

The width d of the slit 131 is sufficiently set to about one half or smaller of the width in the short edge direction of the sheet S to be housed.

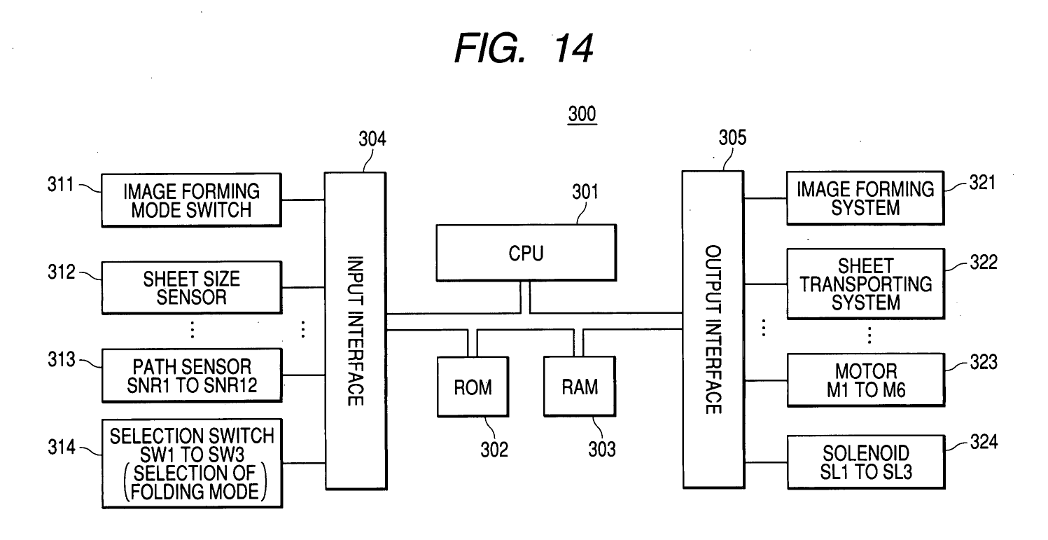

FIG. 14 shows a control system of the sheet processing apparatus of the embodiment.

Referring to the figure, a control device 300 is configured by a microcomputer system having a CPU 301, a ROM 302, a RAM 303, and input and output interfaces 304, 305. The ROM 302 stores a process program for each of process modes (such as an image forming mode, and a postprocessing mode including a folding mode).

In the control device 300, signals from an image forming mode switch 311, a sheet size sensor 312, path sensors 313 including the sensors SNR1 to SNR12, switches SW1 to SW3 serving as a selection switch 314 for selecting the folding mode (in the embodiment, SW1: letter Z-folding selection switch, SW2: letter C-folding selection switch, and SW3: Z-folding selection switch) are supplied to the CPU 301 via the input interface 304. The process program in the ROM 302 is implemented, and the control signals are subjected to calculations while performing data communication with the RAM 303. Thereafter, various control signals are sent via the output interface 305 to an image forming system (such as the image forming module 21) 321, a sheet transporting system 322, motors 323 configured by the motors M1 to M6, and solenoids 324 configured by the solenoids SL1 to SL3.

The selection switches SW1 to SW3 may be disposed on the sheet folding unit 14, or a console panel of the image forming apparatus 11. Of course, the switches may be disposed on both the unit and the control panel.

Next, the operation of the sheet processing apparatus of the embodiment will be described.

In the embodiment, the three modes (the letter Z-folding mode, the letter C-folding mode, and the Z-folding mode) can be selectively executed as the folding mode. Hereinafter, the modes will be sequentially described.

(1) Letter Z-Folding Mode

A job to be performed by the sheet processing apparatus 10 is assumed as a continuous job in which a large number of sheets S are to be processed, such as that, as shown in FIGS. 3 and 14, a predetermined image is formed on each of small-size sheets (for example, JIS A4 size SEF [Short Edge Feed]) which are to be put into envelopes, a letter-folding process (for example, Z-folding) is applied to the sheet, and the sheet is then discharged into the sheet accommodating device 100.

At this time, the user is requested to first operate the image forming mode switch (such as selection of single side printing or double side printing, that of monochrome or color, and postprocessing) 311, designate the number of sheets in the job, and selectively operate the selection switch SW1 (selection of the letter Z-folding mode).

The sheet size is automatically detected by the sheet size sensor 312 (see FIG. 14) disposed in the sheet trays 31 to 33.

As a result of the operations, in the image forming apparatus 11, an image is formed on the each of sheets S by the image forming module 21, the sheet is subjected to a fixing process, and the sheet is then delivered to the sheet postprocessing apparatus 12.

At this time, the sheet S which is discharged from the image forming apparatus 11, and on which an image has been formed is curl-corrected and then sent to the sheet folding unit 14 via the transport unit 13.

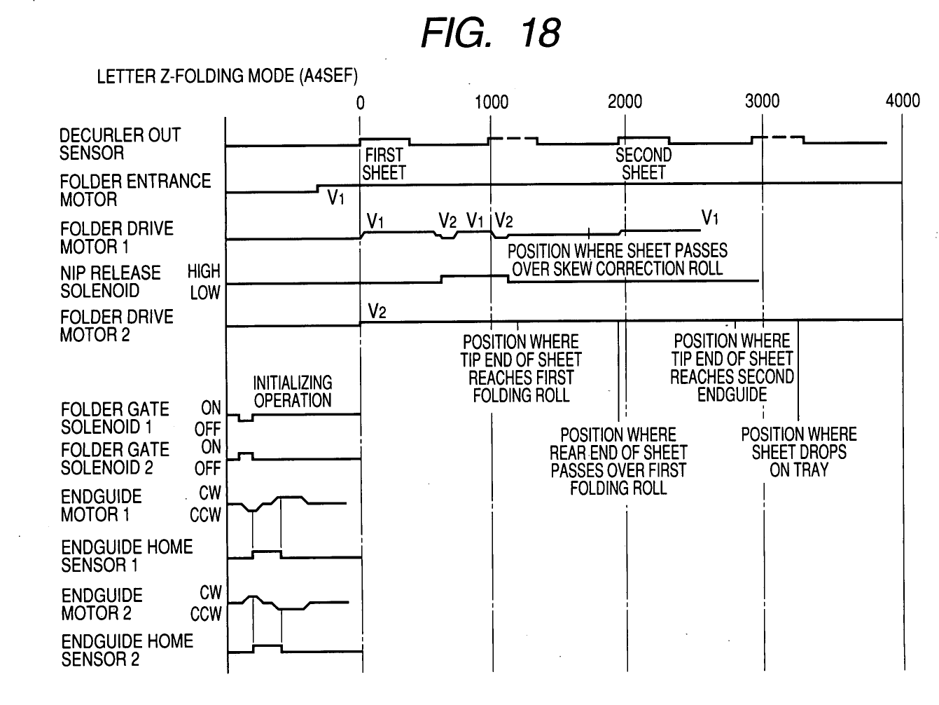

In the sheet folding unit 14, as shown in FIG. 4, the job designation causes the components to be set so that the switch gate 67 enables the sheet movement to the bypass transportation path 62, the end guides 72, 75 are moved to the respective predetermined positions, and the switch gate 78 blocks the sheet movement to the return bypass transportation path 62c (see the initializing operation in FIG. 18).

Particularly, the position of the first end guide 72 is adjusted so that both the lengths L3, L6 shown in FIG. 6 are one third of the object sheet size (in this example, JIS A4 size SEF).

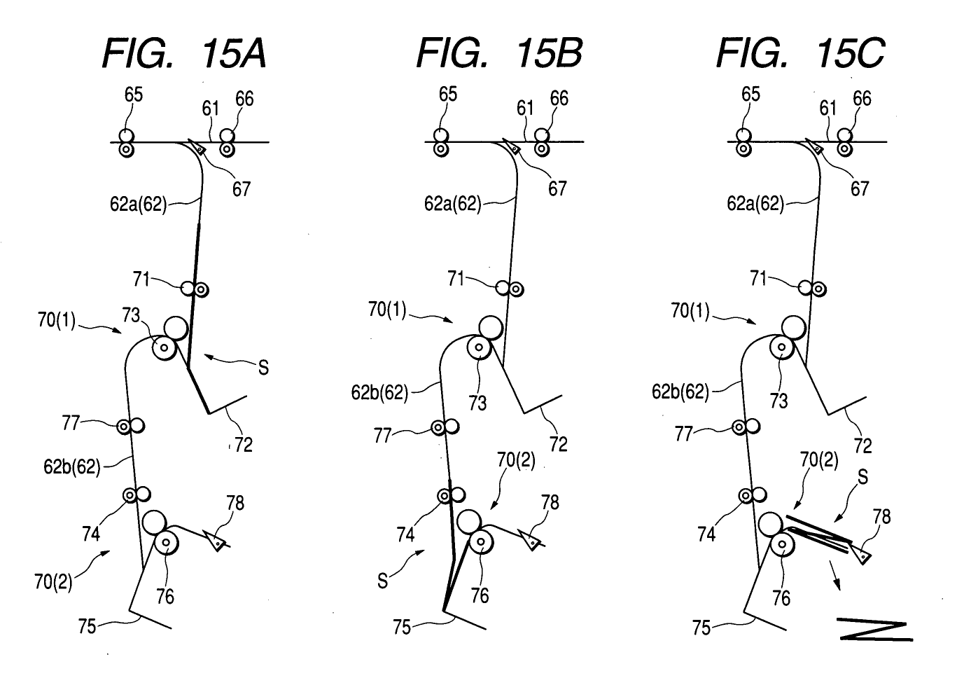

Under this state, as shown in FIG. 15A, the sheet S is transported toward the bypass transportation path 62, guided to the first folding mechanism 70(1), then passed over the skew correction roll 71, and stopped because the tip end of the sheet butts against the first end guide 72.

In the case where the sheet S is skewed in the transportation paths of the image forming apparatus or the upstream postprocessing apparatus (the transport unit 13), when the sheet S is fed to the first folding roll 73 while maintaining the skewed condition, the folding position accuracy is impaired.

In the embodiment, therefore, the skew correction is applied on the sheet S by using the skew correction roll 71.

The skew correction is performed in the following manner. While the sheet S is nip-transported by the skew correction roll 71, the tip end of the sheet S is caused to butt against the first end guide 72. Then, the sheet S is further fed by several mm (for example, about 5 mm) to form a loop. Thereafter, the nipping operation of the skew correction roll 71 is canceled.

In this case, when the nipping operation of the skew correction roll 71 is canceled, the tip end loop of the sheet S tries to return to the straight state. Therefore, the tip end of the sheet S tries to become horizontal along the first end guide 72, and also the rear end of the sheet S tries to become horizontal with following the tip end of the sheet S.

Next, the sheet S in which the skew correction is ended is nipped by the skew correction roll 71, and then transported at a speed which is equal to or lower than that of the first folding roll 73 (in this example, set to a speed [250 mm/sec.] that is lower than the normal speed v1 [800 mm/sec.]), whereby the sheet S is buckled in a space in front of the first folding roll 73 to form a loop, and then fed to the first folding roll 73. A first folding process (in this example, corresponding to the first folding place A of the letter Z-folding shown in FIG. 2) is then performed.

As shown in FIG. 15B, thereafter, the sheet S which has been subjected to the first folding process is guided to the second folding mechanism 70(2) through the transportation rolls 77, and transported through the push roll 74. Then, the tip end of the portion of the sheet S which is folded in the first folding process butts against the second end guide 75 to form a loop, and then fed to the second folding roll 76. A second folding process (in this example, corresponding to the second folding place B of the letter Z-folding shown in FIG. 2) is then performed.

Since the skew correction has been performed in front of the first folding roll 73, the skew correction is not necessary at this timing.

As shown in FIG. 15C, thereafter, the sheet S in which the second folding process is ended, and which is letter Z-folded is discharged through the second switch gate 78 to the sheet accommodating device 100 dedicated to letter-folded sheets S.

FIG. 18 is a timing chart of the sheet folding process.

Referring to FIG. 18, the decurler out sensor (Decurler Out Sensor) is a path sensor which is disposed just in rear of the decurler 54 in the transport unit 13, and the folding unit entrance motor MI is driven so that the start timing is synchronized with the on timing of a decurler in sensor (Decurler In Sensor) disposed in front of the decurler 54.

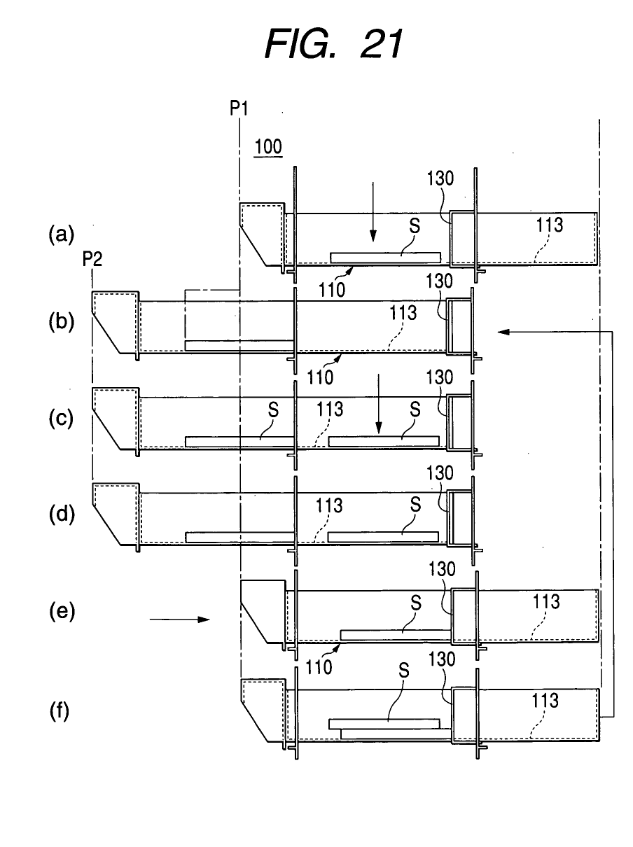

The operation of housing sheets in the sheet accommodating device 100 will be described. It is assumed that the stack tray 110 is at an accommodation position P1 as shown in (a) of FIG. 21. Letter-folded sheets S which are discharged from the second folding roll 76 are sequentially stacked on a normal stacking portion (which means a portion other than the auxiliary stack portion 113) of the stack tray 110.

The case is assumed where, as shown in (b) to (d) of FIG. 21, the user extracts the stack tray 110 to an extraction position P2, and takes out the letter-folded sheets S stacked in the stack tray 110 so that a process of putting the sheets into envelopes is then started.

At this time, even when the stack tray 110 is extracted, the auxiliary stack portion 113 of the stack tray 110 is placed in the place corresponding to the discharging position of the sheets S.

Even when the folding process by the sheet folding unit 14 (see FIG. 4) is continued and the letter-folded sheets S are discharged into the sheet accommodating device 100, therefore, the letter-folded sheets S are stacked on the auxiliary stack portion 113 of the stack tray 110 (see (c) of FIG. 21).

When the user then returns the stack tray 110 to the original accommodation position P1, the sheets S placed on the auxiliary stack portion 113 of the stack tray 110 are blocked by the stopper 130 as shown in (e) of FIG. 21, to be relatively moved to the normal stacking portion of the stack tray 110 in spite of the operation of returning the stack tray 110.

Thereafter, the sheets S which are letter-folded by the sheet folding unit 14 are sequentially stacked on the normal stacking portion of the stack tray 110 as shown in (f) of FIG. 21. In accordance with operations of extracting and returning the stack tray 110, the steps of (b) to (f) of FIG. 21 are then repeated.

(2) Letter C-Folding Mode

The case where the letter C-folding process is to be applied to sheets S of, for example, JIS A4 size SEF will be described. As shown in FIGS. 3 and 14, the user is requested to first operate the image forming mode switch (such as selection of single side printing or double side printing, that of monochrome or color, and postprocessing) 311, designate the number of sheets in the job, and selectively operate the selection switch SW2 (selection of the letter C-folding mode).

In the same manner as the letter Z-folding mode, in the image forming apparatus 11, an image is formed on each of the sheets S by the image forming module 21, the sheet is subjected to a fixing process, and the sheet is then delivered to the sheet postprocessing apparatus 12 (the transport unit 13, the sheet folding unit 14).

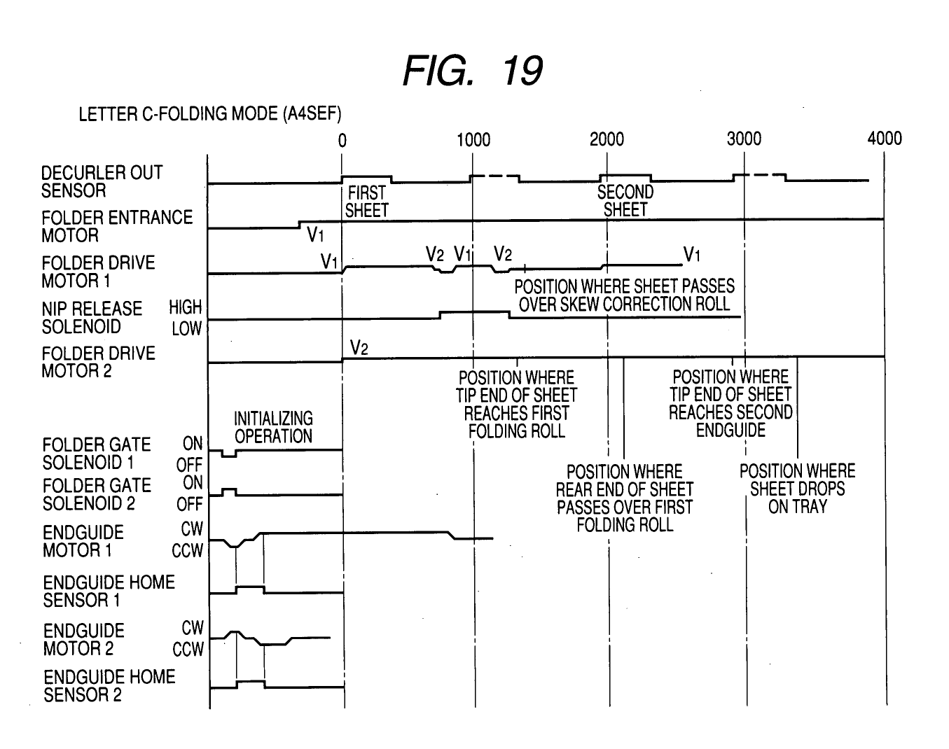

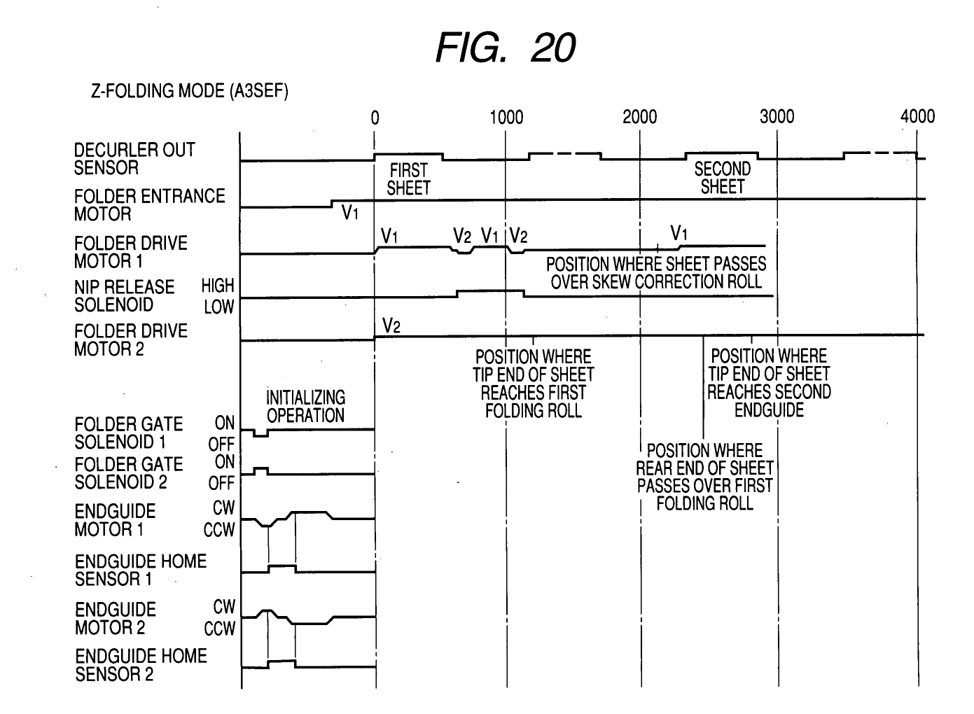

In the sheet folding unit 14, as shown in FIG. 4, the job designation causes the components to be set so that the switch gate 67 enables the sheet movement to the bypass transportation path 62, the end guides 72, 75 are moved to the respective predetermined positions, and the switch gate 78 blocks the sheet movement to the return bypass transportation path 62c (see the initializing operation in FIG. 19).

Unlike the letter Z-folding mode, particularly, the position of the first end guide 72 is adjusted so that the length L3 shown in FIG. 6 is two thirds of the object sheet size (in-this example, JIS A4 size). The position of the second end guide 75 is identical with that in the letter Z-folding mode.

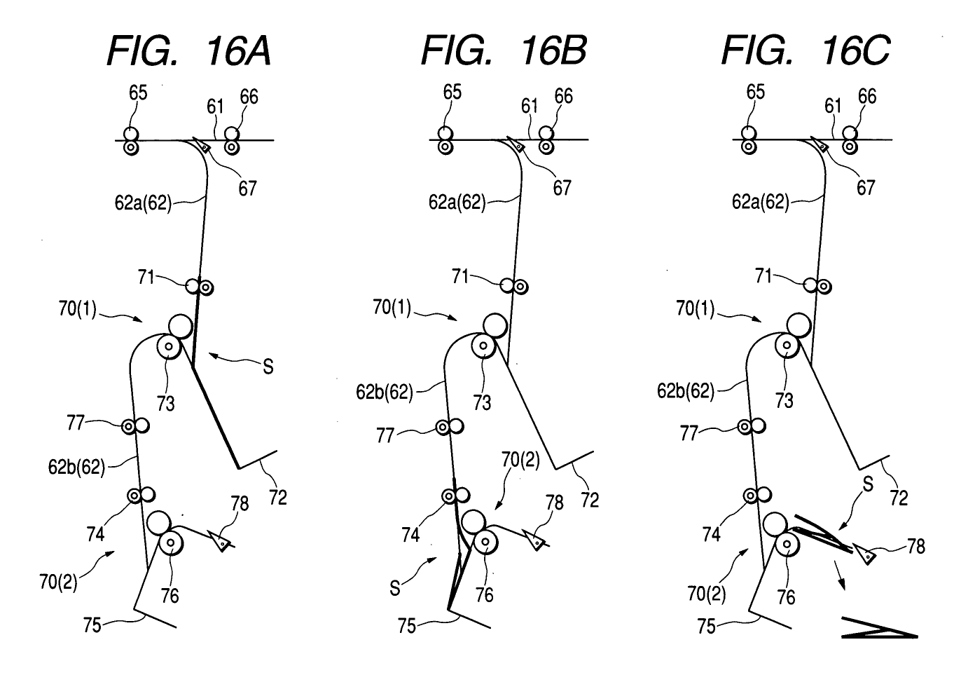

Under this state, as shown in FIG. 16A, the sheet S is transported toward the bypass transportation path 62, guided to the first folding mechanism 70 (1), then passed over the skew correction roll 71, and stopped because the tip end of the sheet butts against the first end guide 72.

In the embodiment, the skew correction is applied on the sheet S by using the skew correction roll 71, and a first folding process (in this example, corresponding to the first folding place A of the letter C-folding shown in FIG. 2) is then performed by the first folding roll 73.

As shown in FIG. 16B, thereafter, the sheet S which has been subjected to the first folding process is guided to the second folding mechanism 70(2). A second folding process (in this example, corresponding to the second folding place B of the letter C-folding shown in FIG. 2) is then performed by the second folding roll 76.

As shown in FIG. 16C, thereafter, the sheet S in which the second folding process is ended, and which is letter C-folded is discharged through the second switch gate 78 to the sheet accommodating device 100 dedicated to letter-folded sheets S.

FIG. 19 is a timing chart of the sheet folding process. (3)Z-folding mode

The case where the Z-folding process is to be applied to sheets S of, for example, JIS A3 size SEF will be described. As shown in FIGS. 3 and 14, the user is requested to first operate the image forming mode switch (such as selection of single side printing or double side printing, that of monochrome or color, and postprocessing) 311, designate the number of sheets in the job, and selectively operate the selection switch SW3 (selection of the Z-folding mode).

In the same manner as the above-described letter folding mode, in the image forming apparatus 11, an image is formed on each of the sheets S by the image forming module 21, the sheet is subjected to a fixing process, and the sheet is then delivered to the sheet postprocessing apparatus 12 (the transport unit 13, the sheet folding unit 14).

In the sheet folding unit 14, as shown in FIG. 4, the job designation causes the components to be set so that the first switch gate 67 enables the sheet movement to the bypass transportation path 62, the end guides 72, 75 are moved to the respective predetermined positions, and, unlike the letter folding mode, the switch gate 78 allows the sheet movement to the return bypass transportation path 62c (see the initializing operation in FIG. 20).

Unlike the letter folding mode, particularly, the position of the first end guide 72 is adjusted so that the lengths L3, L6 shown in FIG. 6 are one fourth of the object sheet size (in this example, JIS A4 size).

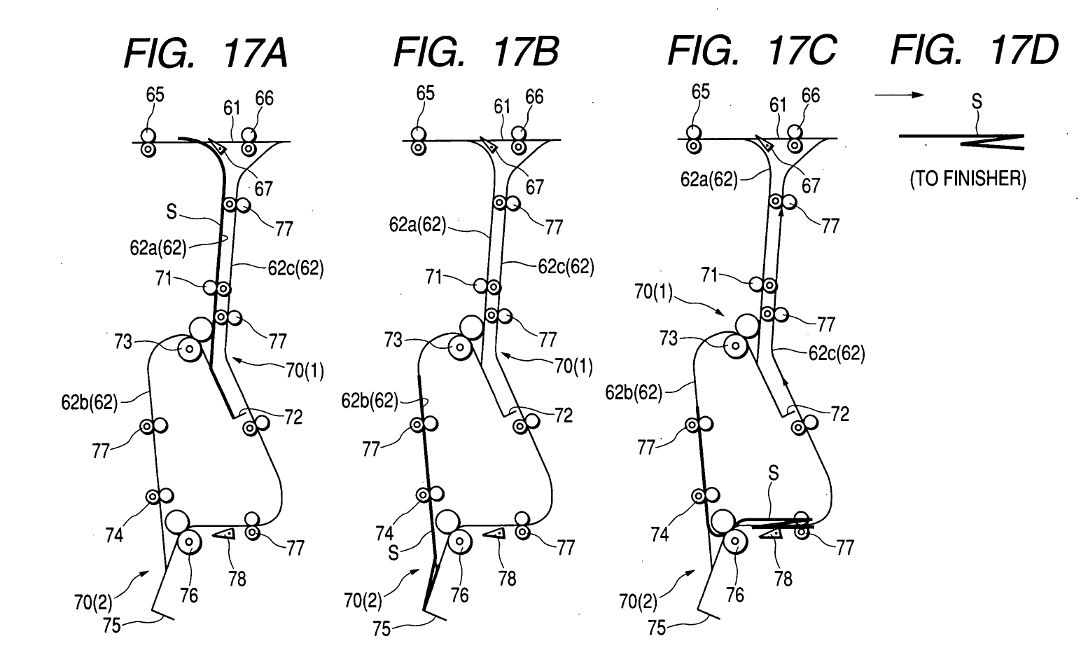

Under this state, as shown in FIG. 17A, the sheet S is transported toward the bypass transportation path 62, and guided to the first folding mechanism 70(1), then passed through the skew correction roll 71, and stopped because the tip end of the sheet butts against the first end guide 72.

In the embodiment, the skew correction is applied on the sheet S by using the skew correction roll 71, and a first folding process (in this example, corresponding to the first folding place A of the Z-folding shown in FIG. 2) is then performed by the first folding roll 73.

As shown in FIG. 17B, thereafter, the sheet S which has been subjected to the first folding process is guided to the second folding mechanism 70(2). A second folding process (in this example, corresponding to the second folding place B of the Z-folding shown in FIG. 2) is then performed by the second folding roll 76.

As shown in FIG. 17C, thereafter, the sheet S in which the second folding process is ended, and which is Z-folded is guided by the second switch gate 78 and then transported by the transportation rolls 77 in the return bypass transportation path 62c to be fed to the finisher 15.

FIG. 20 is a timing chart of the sheet folding process.

In the case where the finisher 15 has been selected to perform predetermined postprocesses (such as a punching process, and a stapling process), the Z-folded sheet in the finisher 15 is transported through the first transportation path 84 as shown in FIG. 3 to be subjected to a punching process by the puncher 91 and also to a stapling process by the stapler 92, and then discharged onto the discharge tray (large-capacity tray) 81.

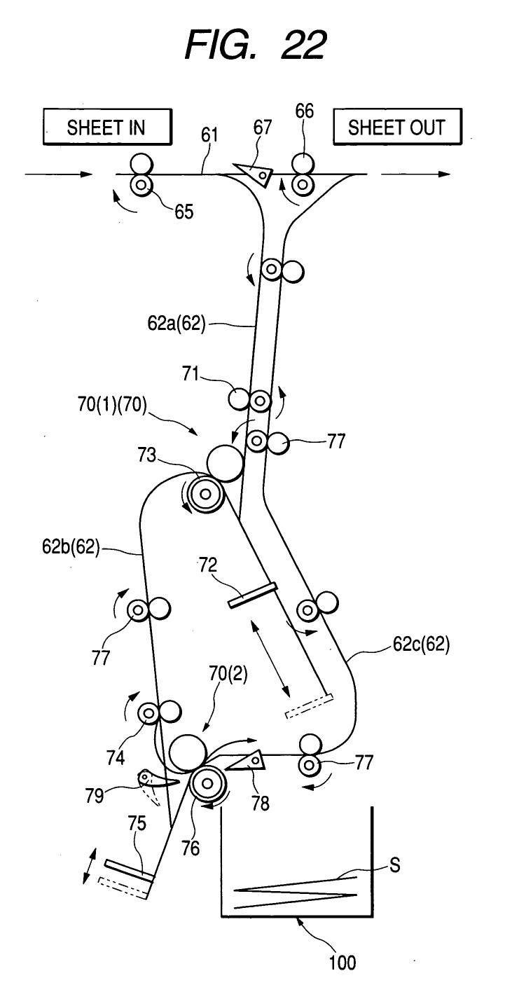

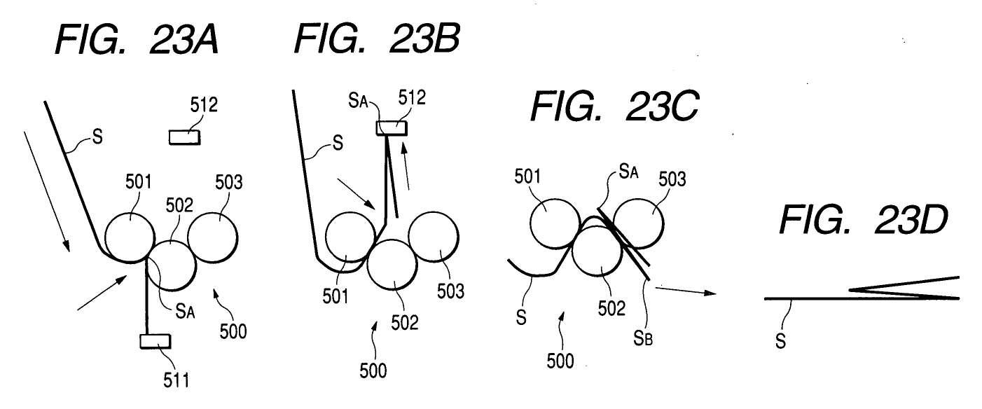

In the embodiment, three-folding is set as the folding mode. In the embodiment, in the case where also two-folding is to be enabled, the followings are performed. As shown in FIG. 22, for example, a switch gate 79 is disposed in front of the second folding roll 76 in the second folding mechanism 70 (2). The sheet S in which the first folding process is ended is directly guided to the second folding roll 76 by the switch gate 79 without being directed to the second end guide 75, so as to be subjected only one time to the folding process. In this case, the position of the first end guide 72 must be adjusted so that the length L3 shown in FIG. 6 is one half of the object sheet size.

As described above, according to the sheet folding apparatus of the invention, a sheet folding unit which can perform at least letter folding is disposed, and a letter folding process is performed in accordance with the folding mode selected through the folding mode selecting device. Therefore, a process of letter folding a sheet can be realized as a sheet-folding process.

In the sheet processing apparatus using such a sheet folding apparatus, a series of sheet processes including letter folding on a sheet can be surely realized.

In the image forming apparatus connectable to such a sheet folding apparatus, a sheet processing apparatus which can perform folding processes including letter folding can be easily structured by combining the image forming apparatus with such a sheet folding apparatus.

What is claimed is:

1. A sheet folding apparatus comprising:
a sheet folding unit which can apply at least letter folding on a sheet; and
a folding mode selecting device which can selectively cause the sheet folding unit to operate in a letter folding mode.

2. The sheet folding apparatus according to claim 1, further comprising a control device which controls the sheet folding unit in accordance with a folding mode selected by the folding mode selecting device.

3. The sheet folding apparatus according to claim 1, wherein the letter folding includes at least one of letter C-folding and letter Z-folding.

4. The sheet folding apparatus according to claim 1, wherein the sheet folding unit comprises a plurality of folding mechanisms in a sheet path.

5. The sheet folding apparatus according to claim 4, wherein at least one of the folding mechanisms comprises a folding position changing mechanism which can change a sheet folding position.

6. The sheet folding apparatus according to claim 4, wherein, among the folding mechanisms, an upstream folding mechanism comprises a skew correcting mechanism which applies skew correction on the sheet.

7. The sheet folding apparatus according to claim 4, wherein at least one of the folding mechanisms comprises: a folding member which is disposed in a sheet path to nip-transport the sheet; a transport member which is disposed in the sheet path upstream from the folding member to nip-transport the sheet; and a tip end guide member which is disposed in the sheet path upstream from the folding member to restrict a position of a tip end of the sheet.

8. The sheet folding apparatus according to claim 7, wherein the folding mechanism comprises a folding position changing mechanism which moves the tip end guide member that is movable, to enable a sheet folding position to be changed.

9. The sheet folding apparatus according to claim 7, wherein, in the folding mechanism, a skew correcting mechanism which applies skew correction on the sheet is configured by the transport member which can perform nipping and releasing operations, and the tip end guide member.

10. The sheet folding apparatus according to claim 9, wherein, after a tip end of the sheet butts against the tip end guide member, the skew correcting mechanism causes the transport member to transport the sheet by a short distance to form a loop on a side of the tip end of the sheet, and thereafter causes the transport member to perform the releasing operation.

11. The sheet folding apparatus according to claim 9, wherein a feeding mechanism nips the sheet that has subjected to skew correction by the skew correcting mechanism, by the transport member, then sets a transportation speed of the transport member to a speed which is equal to or lower than a speed of the folding member, and feeds the sheet that has been subjected to skew correction to the folding member.

12. A sheet folding apparatus comprising:
a sheet folding unit which can apply at least both Z-folding and letter folding on a sheet; and
a folding mode selecting device which can selectively cause the sheet folding unit to operate in either of folding modes.

13. The sheet folding apparatus according to claim 12, further comprising a control device which controls the sheet folding unit in accordance with a folding mode selected by the folding mode selecting device.

14. The sheet folding apparatus according to claim 12, wherein the letter folding includes at least one of letter C-folding and letter Z-folding.

15. The sheet folding apparatus according to claim 12, wherein the sheet folding unit performs Z-folding and letter folding on a sheet, by using a common folding mechanism.

16. A sheet processing apparatus comprising:
a sheet folding apparatus including a sheet folding unit which can apply at least letter folding on a sheet, and a folding mode selecting device which can selectively cause the sheet folding unit to operate in a letter folding mode.

17. A sheet processing apparatus comprising:
a sheet folding apparatus including a sheet folding unit which can apply at least both Z-folding and letter folding on a sheet, and a folding mode selecting device which can selectively cause the sheet folding unit to operate in either of folding modes.

18. The sheet processing apparatus according to claim 16, further comprising a sheet folding postprocessing apparatus which applies a predetermined postprocess on a sheet that has been subjected to a folding process by the sheet folding apparatus.

19. The sheet processing apparatus according to claim 18, further comprising a control device which controls at least the sheet folding apparatus and the sheet folding postprocessing apparatus in accordance with a postprocessing mode applied on the sheet.

20. The sheet processing apparatus according to claim 19, wherein the control device houses a letter-folded sheet into a sheet accommodating device in the sheet folding apparatus, under conditions of performing a letter folding process on the sheet by the sheet folding apparatus.

21. The sheet processing apparatus according to claim 19, wherein the control device guides a folded sheet to the sheet folding postprocessing apparatus, under conditions of performing Z-folding other than letter folding on the sheet by the sheet folding apparatus.

22. The sheet processing apparatus according to claim 17, further comprising a sheet folding postprocessing apparatus which applies a predetermined postprocess on a sheet that has been subjected to a folding process by the sheet folding apparatus.

23. The sheet processing apparatus according to claim 22, further comprising a control device which controls at least the sheet folding apparatus and the sheet folding postprocessing apparatus in accordance with a postprocessing mode applied on the sheet.

24. The sheet processing apparatus according to claim 23, wherein the control device houses a letter-folded sheet into a sheet accommodating device in the sheet folding apparatus, under conditions of performing a letter folding process on the sheet by the sheet folding apparatus.

25. The sheet processing apparatus according to claim 23, wherein the control device guides a folded sheet to the sheet folding postprocessing apparatus, under conditions of performing Z-folding other than letter folding on the sheet by the sheet folding apparatus.

26. A sheet processing apparatus comprising:
an image forming apparatus which applies an image forming process on a sheet; and
a sheet postprocessing apparatus which includes a sheet folding apparatus having a sheet folding unit that can apply at least letter folding on a sheet and a folding mode selecting device that can selectively cause the sheet folding unit to operate in a letter folding mode, and which applies a predetermined postprocess on the sheet that has been subjected to the image forming process by the image forming apparatus.

27. A sheet processing apparatus comprising:
an image forming apparatus which applies an image forming process on a sheet; and
a sheet postprocessing apparatus which includes a sheet folding apparatus having a sheet folding unit that can apply at least both Z-folding and letter folding on a sheet and a folding mode selecting device that can selectively cause the sheet folding unit to operate in either of folding modes, and which applies a predetermined postprocess on the sheet that has been subjected to the image forming process by the image forming apparatus.

28. The sheet processing apparatus according to claim 26, further comprising a control device which controls the image forming apparatus and the sheet postprocessing apparatus in accordance with a process mode applied on the sheet.

29. The sheet processing apparatus according to claim 27, further comprising a control device which controls the image forming apparatus and the sheet postprocessing apparatus in accordance with a process mode applied on the sheet.

30. An image forming apparatus connectable to a sheet folding apparatus which can apply at least letter folding on a sheet, the image forming apparatus comprising:
a folding mode selecting device which can select a folding mode of the sheet folding apparatus.
